(19) United States
(12) Patent Application Publication
(10) Pub. No.: US 2011/0279679 A1
(43) Pub. Date: Nov. 17, 2011

(54) APPARATUS AND METHOD FOR OBTAINING AN IMAGE OF A FLUORESCENT PATTERN UNDER AMBIENT LIGHT

(76) Inventors: Ifor David William Samuel, St. Andrews (GB); Mario Giardini, St. Andrews (GB)

(21) Appl. No.: 13/131,992

(22) PCT Filed: Dec. 1, 2009
(86) PCT No.: PCT/GB2009/051627

§ 371 Date: Aug. 3, 2011

(30) Foreign Application Priority Data
Dec. 1, 2008 (GB) 0821873.7

(51) Int. Cl. H04N 5/30

(52) U.S. Cl. 348/162; 348/E05.085

(57) ABSTRACT

The invention provides an imaging apparatus (10) for obtaining an image (40) of a fluorescent pattern (32) under ambient light, such as a fluorescent barcode or a fingerprint dyed with a fluorescent marker. The apparatus includes a synchronous shutter imaging device (12) having an image recording sensor and a shutter, a first pulsed light source (18) which emits a pulse of light having an excitation wavelength of the fluorescent pattern, an optical filter (14) which prevents light having the excitation wavelength from reaching the image recording sensor of the synchronous shutter imaging device, and a synchronisation control (22) which synchronises the shutter and the pulsed light source. The synchronisation of the shutter and pulse, so that the shutter opens during the pulse, and the provision of the optical filter allow a low intensity light source to be used and an image to be obtained under ambient light conditions.

The present invention relates to an apparatus and method for obtaining an image of a fluorescent pattern under ambient light. In one example the invention relates to an apparatus and method for obtaining an image of a weakly fluorescent object such as a fingerprint or marker, which may either autofluoresce or have been stained with a fluorescent dye, in situ under ambient light, without the need to move the object to a laboratory environment.

It is known in the prior art to obtain images of fluorescent fingerprints. Such imaging is used in police and forensic laboratories, as part of the process of searching for evidence on objects collected at crime scenes. Typically a fingerprint on an object is stained with a fluorescent dye. The object is then taken to a dark room, and is observed under a very intense monochromatic or quasi-monochromatic illuminator, through a filter screen or filter goggles which block light of the wavelength emitted by the illuminator. Both a filter screen and filter goggles may be used simultaneously, to protect the operator from excessive light. For safety reasons goggles must be worn by any other person who may be present in the room where the illuminator is used.

By way of example, an object such as a plastic carrier bag suspected to carry fingerprints may be found at a crime scene. The object is carried to the laboratory, where it is exposed to cyanoacrylic glue fumes, and subsequently immersed in a solution of a fluorescent chemical known in the art as Basic Yellow. The process stains the fingerprints with Basic Yellow. The object is then dried, taken to a dark room, and viewed under blue illumination, using an orange screen and orange protective goggles, to search for fingerprints on the object.

It is also known to use autofluorescence of the fingerprint instead of using a fluorescent dye. The fingerprint is illuminated with a very strong ultraviolet light source and autofluoresces very weakly. The autofluorescence can be observed through an intensified camera, protecting the operators from the very intense ultraviolet radiation. The technique suffers from the disadvantage that the autofluorescence can be rapidly killed by the excitation light itself, in a process known as photobleaching.

It is an object of the present invention to allow the safe imaging of fluorescent patterns, such as fingerprints or fluorescent markers, under ambient light conditions, to avoid the need for removal to a laboratory and dark room, and to avoid the substantial operator protection required by the continuous intense illumination of the prior art imaging methods.

According to a first aspect of the invention there is provided an imaging apparatus for obtaining an image of a fluorescent pattern under ambient light, comprising:
a synchronous shutter imaging device having an image recording sensor and a shutter,
a first pulsed light source adapted to emit a pulse of light having an excitation wavelength of the fluorescent pattern,
an optical filter adapted to prevent light having the excitation wavelength from reaching the image recording sensor of the synchronous shutter imaging device, and
a synchronisation control adapted to synchronise the shutter of the synchronous shutter imaging device and the pulsed light source.

A synchronous shutter imaging device as referred to in this specification is an imaging device in which the surface of the image recording sensor, for example all the pixels in a digital imager, or all the film surface in a film camera, are subject to gating or shuttering at the same time.

The shutter may be a mechanical or electrooptical shutter or gate. The shutter may be an electronic shutter or gate, for example switching on and off a CCD detector or similar.

The fluorescent pattern may be a fingerprint, a security marking, a motion detection marker, an identification marker, a fluorescent barcode, or an anatomical feature.

The fluorescent pattern may be dyed with a fluorescent dye, such as Basic Yellow. Alternatively the fluorescent pattern may be autofluorescent. The pulsed light source may have an excitation wavelength of between 180 nm and 1000 nm. In one embodiment it may be about 450 nm.

The synchronisation control is preferably adapted to synchronise the shutter such that opening of the shutter at least partially overlaps the pulse of light emitted by the first light source. It may be synchronised such that it opens when the pulse starts or a pre-determined time after the pulse starts.

Preferably the synchronous shutter imaging device has a shutter speed which is controllable to a first shutter speed which is sufficiently fast to limit ambient light reaching the image recording sensor of the synchronous shutter imaging device to an amount which does not adversely affect the image of the fluorescent pattern. The shutter speed may also be controllable to a second shutter speed which allows ambient light to reach the image recording sensor of the synchronous shutter imaging device to produce an image under ambient light.

The imaging device may be adapted to acquire images in digital or analogue format. The image recording sensor may be an electronic sensor or a chemical sensor such as photographic film.

The image recording sensor may comprise one or more sensing units selected from the group including: CCD units, CMOS units, EMCCD units, MCP intensified units, units containing organic semiconducting materials, photomultipliers, vidicons, photodiodes, photoresistors, microbolometers, and thermal sensors.

The image recording sensor may comprise a plurality of sensing units arranged in a matrix. The term “matrix” includes linear arrays and surface arrays.

The imaging device may include a lens or an aperture. The shutter may be provided between the image recording sensor and the lens or aperture. Alternatively the shutter may be provided between the fluorescent pattern and the lens or aperture. Alternatively the shutter may be a gate comprising an electronic gate control of the sensing units of the image recording sensor.

The synchronisation control may include a microprocessor.

The imaging apparatus may comprise more than one pulsed light source and the synchronisation control may be adapted to control the more than one pulsed light source to synchronise the shutter of the synchronous shutter imaging device with the more than one pulsed light source.

The or each pulsed light source may comprise one or more mutually synchronised LEDs or other pulsed lights. Each pulsed light source may emit light of a different wavelength. The pulsed light sources may include at least one pulsed light source adapted to emit a pulse of light having an excitation wavelength of the fluorescent pattern and at least one pulsed light source adapted to emit a pulse of light having a different wavelength not blocked by the filter and enabling visualisation of the object. This enables two corresponding images to be obtained, one of the fluorescent pattern and one of the object on which the pattern is located, thereby assisting in identifying the position of the fluorescent pattern on the object.

The pulsed light sources may include at least one pulsed light source adapted to emit a pulse of light having an excitation wavelength of a first fluorescent pattern and at least one pulsed light source adapted to emit a pulse of light having a second excitation wavelength of a second fluorescent pattern. The first and second fluorescent patterns may be superimposed on each other, and separate images can thus be obtained of each pattern.

The synchronisation control may be adapted to control one or more of the time for which the shutter is open, the duration of the pulse of light, the intensity of the pulse of light, the sensitivity of the synchronous shutter imaging device, and the temporal relationship of the start and finish of pulse with respect to the opening and closing of the shutter.

Preferably the imaging apparatus comprises a single housing which contains the synchronous shutter imaging device, the one or more pulsed light sources, the optical filter and the synchronisation control. The housing may include wired or wireless connection means to allow remote viewing, storage and processing of the image by means of a computer connected to the connection means.

According to a second aspect of the present invention there is provided a method of obtaining an image of a fluorescent pattern under ambient light using a synchronous shutter imaging device having an image recording sensor and a shutter, the method comprising:
illuminating the fluorescent pattern with a first pulse of light having an excitation wavelength of the fluorescent pattern,
opening the shutter of the synchronous shutter imaging device in synchronisation with the pulse of light for a period of time sufficiently short to limit ambient light reaching the image recording sensor to an amount which does not adversely affect the image of the fluorescent pattern,
collecting emitted fluorescent light from the fluorescent pattern through an optical filter adapted to prevent light having the excitation wavelength from reaching the image recording sensor of the synchronous shutter imaging device, and
recording on the image recording sensor an image generated by the emitted fluorescent light.

The period of time for which the shutter is opened may typically be 10 μs or less. Preferably the period of time for which the shutter is opened at least partially overlaps with the time for which the fluorescent pattern is illuminated with the pulse of light.

The shutter may be an electronic, mechanical or electrooptical shutter or gate. The shutter may be a gate comprising an electronic gate control of the sensing units of the image recording sensor.

The fluorescent pattern may be a fingerprint, a security marking, a motion detection marker, an identification marker, a fluorescent barcode, or an anatomical feature. The anatomical feature or other pattern may be subject to autofluorescence or to fluorescence enhancement.

The method may include the step of dyeing a pattern, such as a fingerprint, with one or more fluorescent dyes, such as Basic Yellow, to create the fluorescent pattern. Alternatively the fluorescent pattern may be autofluorescent. The pulsed light source may have an excitation wavelength of between 180 nm and 1000 nm. If using Basic Yellow, the wavelength may preferably be about 450 nm.

In a preferred embodiment the method includes the step of controlling the period of time for which the shutter is open. The period of time may be selected dependent on one or more of the following: the level of ambient light, the relative emission intensity, optimising the measured signal for image processing.

The images obtained may be in digital or analogue format. The image recording sensor may be an electronic sensor or a chemical sensor such as photographic film.

The image recording sensor may comprise one or more sensing units selected from the group including: CCD units, CMOS units, EMCCD units, MCP intensified units, units containing organic semiconducting materials, photomultipliers, vidicons, photodiodes, photoresistors, microbolometers, and thermal sensors.

The image recording sensor may comprise a plurality of sensing units arranged in a matrix or a linear array.

The synchronisation control may include a microprocessor.

The method may include obtaining a second image of the fluorescent pattern under non-fluorescing conditions by:
illuminating the fluorescent pattern with a second pulse of light having a wavelength other than the excitation wavelength of the fluorescent pattern,
opening the shutter of the synchronous shutter imaging device in synchronisation with the second pulse of light for a second period of time to permit light reflected from the image to pass through the optical filter to the image recording sensor, and
recording on the image recording sensor an image generated by light reflected from the object.

The emitted or reflected light from the object resulting from the second pulse of light may pass through the optical filter since it does not have a wavelength equal to the excitation wavelength.

The first and second pulses of light may be generated by first and second pulsed light sources respectively.

The method may include obtaining a further image of the fluorescent pattern by:
illuminating the fluorescent pattern with a further pulse of light having a wavelength equal to a second excitation wavelength of the fluorescent pattern,
opening the shutter of the synchronous shutter imaging device in synchronisation with the further pulse of light for a further period of time,
collecting emitted fluorescent light from the fluorescent pattern, and
recording on the image recording sensor an image generated by the emitted fluorescent light.

Preferably the further period of time is sufficiently short to limit ambient light reaching the image recording sensor to an amount which does not adversely affect the image of the fluorescent pattern.

The emitted fluorescent light may be collected through a second optical filter adapted to prevent light having the second excitation wavelength from reaching the image recording sensor of the synchronous shutter imaging device.

The method may comprise the steps of controlling one or more of the following:
the time for which the shutter is open,
the duration of the pulse or pulses of light,
the intensity of the pulse or pulses of light,
the sensitivity of the synchronous shutter imaging device, and
the temporal relation of the start and finish of the pulse or pulses of light with respect to the opening and closing of the shutter.

The invention will now be described, by way of example only, with reference to the following drawings:

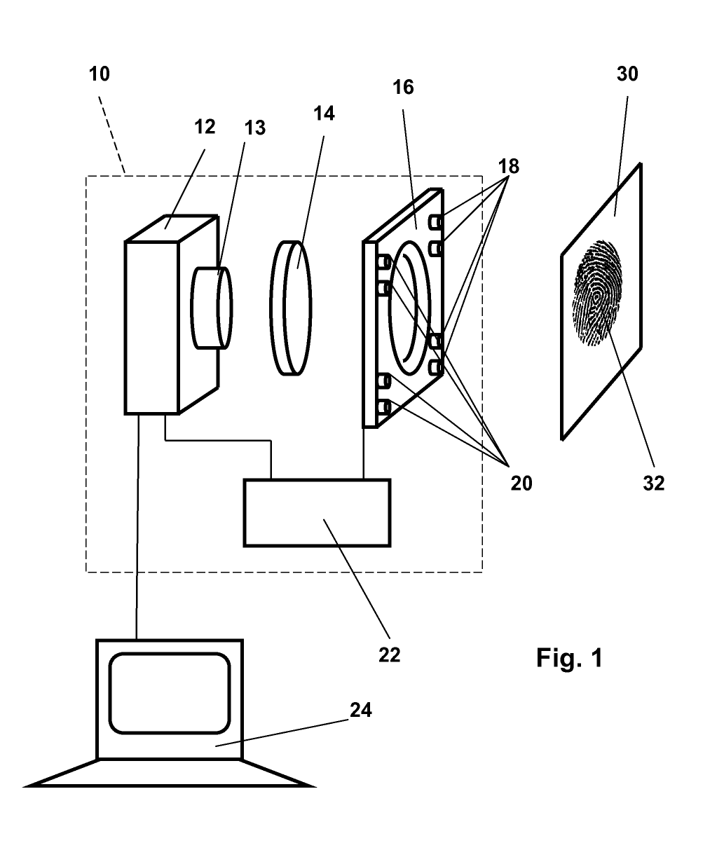

FIG. 1 shows schematically an embodiment of an imaging apparatus according to the present invention for obtaining an image of a fluorescent pattern under ambient light;

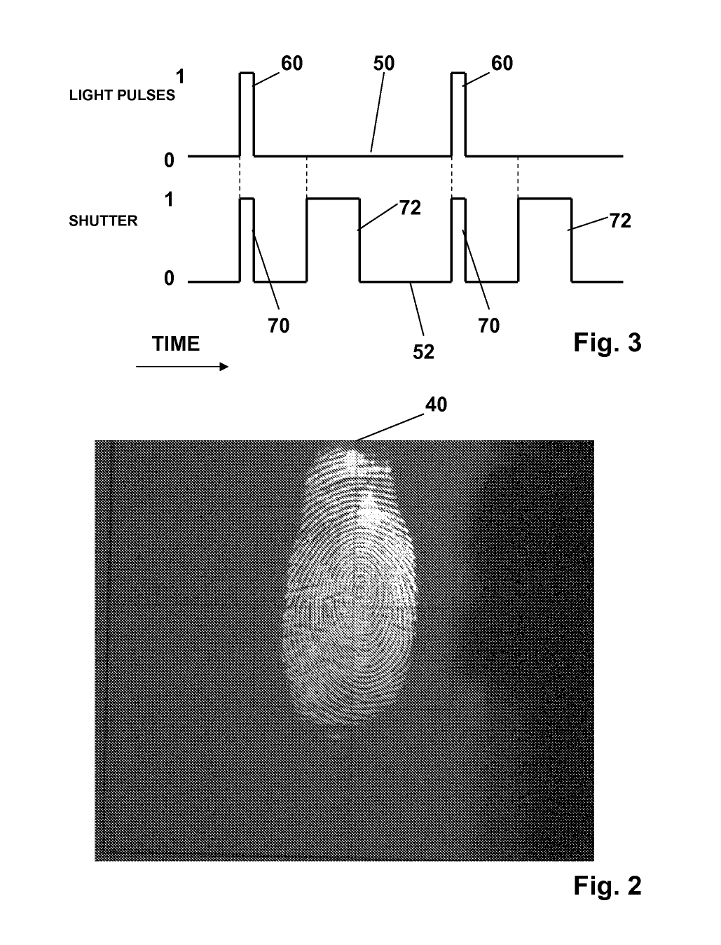

FIG. 2 shows an image produced by the imaging apparatus of FIG. 1;

FIG. 3 shows an example of the temporal relation between the shutter opening and closing and the pulsed light source of an imaging apparatus according to the present invention;

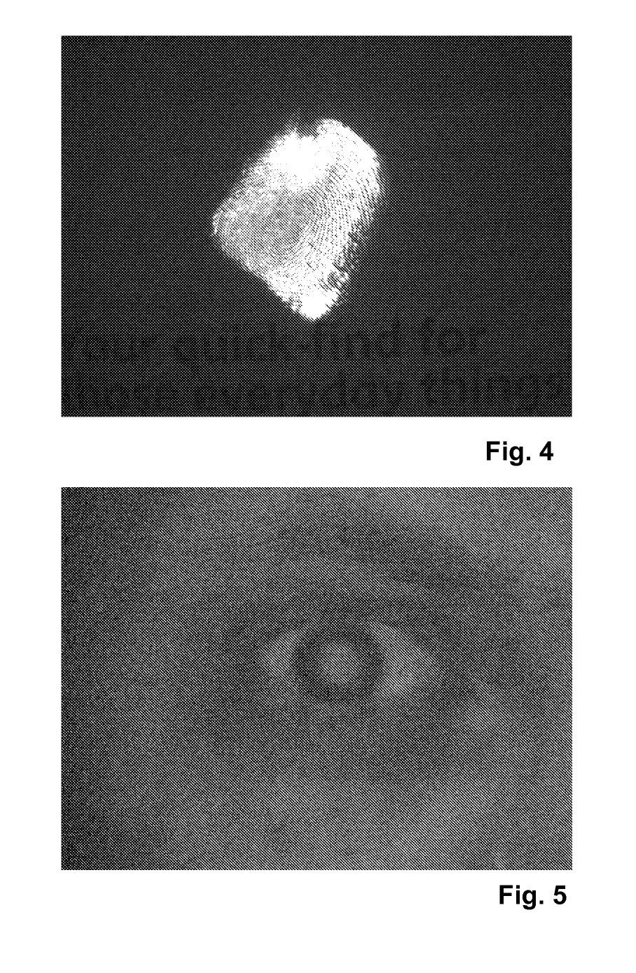

FIG. 4 shows a fingerprint image on paper produced by an imaging apparatus of the present invention using a fluorescent dye;

FIG. 5 shows an image of an eye pupil produced by an imaging apparatus of the present invention using the autofluorescence of the eye pupil;

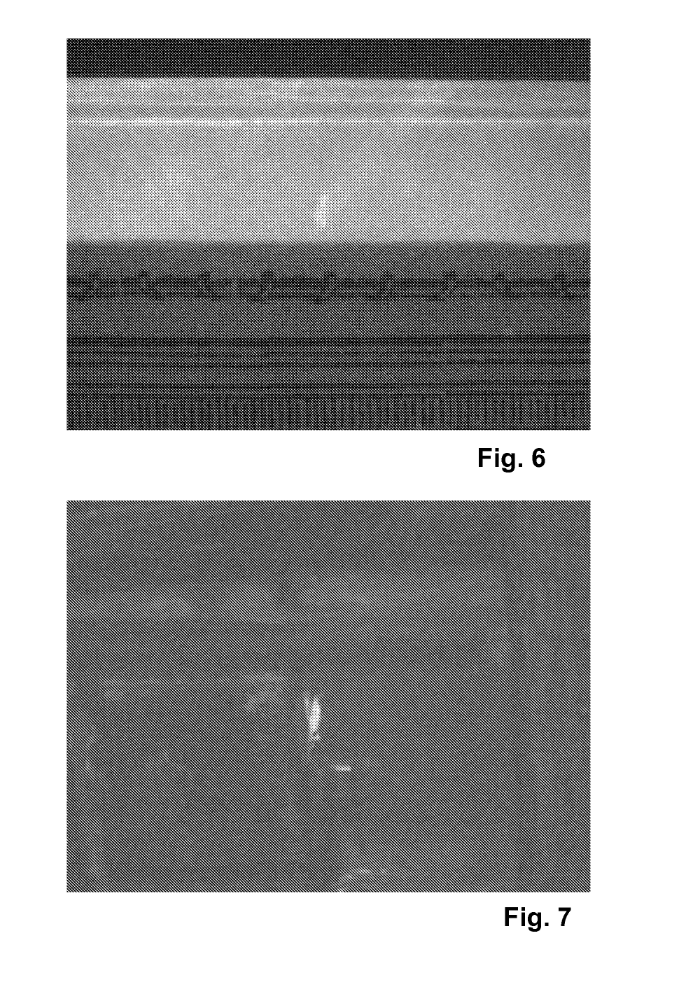

FIG. 6 shows an image of fungal growth on parchment produced by an imaging apparatus of the present invention using the autofluorescence of the fungus;

FIG. 7 shows an image of paint pigment on a book produced by an imaging apparatus of the present invention using the autofluorescence of the pigment; and

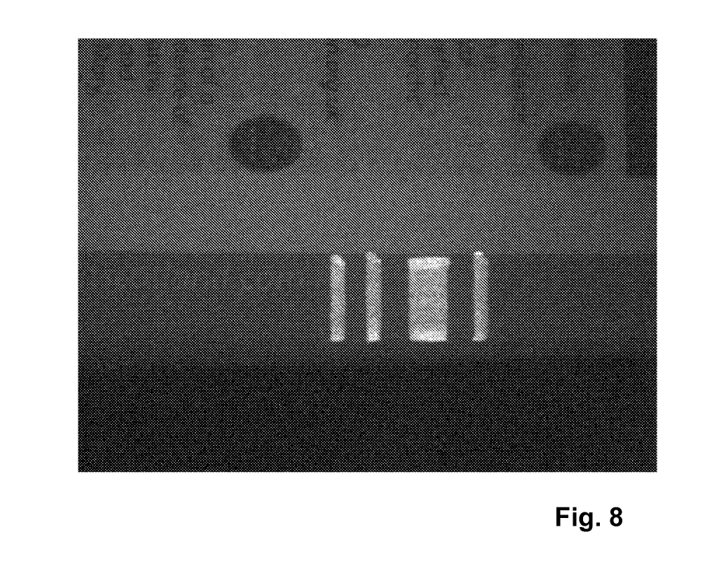

FIG. 8 shows an image of a fluorescent barcode on paper produced by an imaging apparatus of the present invention.

With reference to FIG. 1, there is shown a synchronous shutter imaging device. In this embodiment the imaging apparatus 10 is used for the detection of fluorescent fingerprints 32 and is a self-contained camera unit 10 in a single housing (not shown). The apparatus includes a CCD digital video imager 12 and lens 13, with a fast shutter speed. The video imager 12 includes an image recording sensor (not shown) and a shutter (not shown) to control the exposure of the image recording sensor to light entering the video imager 12. The invention is not limited to a CCD digital video imager, and any appropriate form of imager or camera may be used, provided that it includes a synchronous shutter capable of appropriately fast shutter speeds.

A circuit board 16, integrated in the front side of the self-contained unit 10, carries a first set of mutually synchronised LED pulsed light sources 18 which emit light at a first wavelength and a second set of mutually synchronised LED pulsed light sources 20 which emit light at a second wavelength. The light sources 18, 20 are mounted so as to illuminate an object 30 located in the field of view of the camera unit 10. A synchronisation circuit 22 synchronises the pulses generated by the pulsed light sources 18, 20 and the shutter (not shown) in the CCD digital video imager.

The shutter may be a mechanical or electrooptical shutter or gate. Alternatively the shutter may be an electronic shutter or gate comprising an electronic gate control of the sensing units of the image recording sensor, for example switching on and off a CCD detector. In this specification opening and closing a shutter can thus refer to an electronic control which switches a detector or imager on and off.

Although the illustrated embodiment shows four pulsed light sources 18, in each set, it is to be understood that each set may comprise any suitable number of discrete light sources, including a single light source. Furthermore, the second set of light sources 20 may be omitted, as will be described below. The invention is not limited to LED light sources, and any suitable sources may be used.

The object 30 has a fluorescent pattern 32 on it in the form of a fingerprint, which has been coloured with a fluorescent dye in the manner known in the art, for example by coating or immersing in a solution of fluorescent chemical such as Basic Yellow.

The first set of pulsed light sources 18 emits light at a first wavelength in the blue spectrum, typically of the order of 450 nm. Generally the wavelength is in the range 320 nm to 520 nm, ultraviolet to green. The wavelength is the excitation wavelength of the fluorescent pattern 32, and so when light from the first pulsed source 18 illuminates the fluorescent pattern 32, fluorescent light is emitted at a second different wavelength, typically in the visible or neat-infrared spectrum.

An optical filter 14 in the line of sight of the video imager 12 blocks the light of the first wavelength emitted by the first set of sources 18 and lets the light of the second wavelength emitted by the fluorescence of the fluorescent pattern 32 pass through. The imaging apparatus 10 of the invention always has an optical filter 14 present in the line of sight of the video imager 12, and does not require the removal of the filter 14 to obtain an image produced under background illumination. If required, the apparatus may include more than one optical filter 14 between which the operator selects, depending on the wavelength of the pulsed light source to be used. The selection of the appropriate filter 14 can be automated with the selection of the pulsed light source.

The second set of pulsed light sources 20 emits light at a third wavelength, different to the first wavelength, which allows the light to pass through the filter. Typically this wavelength does not cause excitation of the fluorescent pattern 32, although it may. The optical filter 14 allows light of the third wavelength emitted by the second set of sources 20 to pass through.

In use, the fluorescent pattern 32 on the object 30 is illuminated by light at the first wavelength from the first set of sources 18, which are synchronised by the synchronisation control 22 to emit pulses while the shutter is open for a first period of time. As a result the fluorescent pattern 32 fluoresces. Since the fluorescence is synchronised with the camera shutter, it is detected by the camera 10, thereby allowing an image 40 of the pattern 32 to be recorded on the image recording sensor. A typical image 40 is shown in FIG. 2.

If a visual image of the object is required together with the image of the pattern, the object 30 may also be illuminated by light at the third wavelength from the second sources 20, with an intensity selected by the operator. The second sources 20 are synchronised by the synchronisation control 22 to emit pulses while the shutter is open for a second period of time, after the first period of time. The third wavelength is not blocked by the filter 14 in the line of sight of the camera 10. The filter 14 therefore allows the light reflected and/or diffused by the object to pass through the shutter to the image recording sensor, thereby allowing a visual image of the object 30 to be recorded on the image recording sensor. Because this visual image is of the same field of view as the image of the pattern recorded using emitted fluorescent light from the fluorescent pattern, the visual image allows a user to locate the fluorescent pattern on the object.

The step of illumination by light from the second sources 20 can be omitted if a visual image of the object 30 is not required.

In an alternative embodiment, the fluorescent pattern 32 is not obtained by colouring with a fluorescent dye, but is an autofluorescing pattern. The light source 18 is a high intensity ultraviolet light source, for example one or more high power UV LEDs.

An external computer 24 can be connected to the camera 10 by a cable 26 or other suitable wireless or wired connection means to enable visualisation of the image 40 detected by the camera 10. The computer 24 may acquire the image 40 and store it, and may be used to subject the image to post-processing. The post-processing can involve either single images, or multiple images, according to techniques well established in the state of the art, such as, for example, superposition, contrast and gamma adjustment, averaging, and stabilisation of movement.

The image produced by the imaging apparatus 10 can be read or viewed by the user by any appropriate means every time the shutter is opened, or it can be read or viewed after a number of shutter openings, as required.

The computer 24 may also control the camera and the synchronisation control to implement different synchronisation patterns, or to control the shutter time. This is useful, for example, to optimise the opening time taking account of ambient light conditions. In low light the shutter may be opened for longer during the pulse from the first light source 18, resulting in a higher quality image of the fluorescent pattern. In another example, the visualization of the object may also be implemented by the computer controlling the shutter time so that in alternating frames a given amount of ambient light is allowed to be detected by the camera. FIG. 3 shows how the shutter and light pulse may be synchronised in such an example. The upper part 50 of FIG. 3 shows the level of light emitted by the pulsed light source 18 over time. The level is at zero except for the duration of the pulse 60, typically a few microseconds to a few nanoseconds. The lower part 52 of FIG. 3 shows the opening and closing of the shutter over time. The shutter is opened for a very short time 70 in synchronisation with the pulse 60 of the LED source 18, and then the shutter is opened for a longer time 72 while the light level of the pulsed light source 18 remains at zero, thereby allowing detection by the image recording sensor of the object under ambient light conditions. The opening of the shutter repeats with a short time 70, longer time 72, short time 70, longer time 72 and so on. The images created by the successive shutter opening times 70, 72 are recorded on consecutive frames. As will be described later, synchronisation of the shutter and pulse includes cases where the shutter is open during the pulse as well as cases where the shutter overlaps with the pulse or commences a predetermined time interval after the end of the pulse.

When a fluorescent pattern is subjected to excitation, it will continue to fluoresce after the excitation light source is removed. Thus, by synchronising the shutter and pulsed light source such that there is a predetermined delay between the light pulse and the opening of the shutter, it is possible to obtain an image of the fluorescent pattern after the light pulse is terminated and while the pattern is still fluorescing. In this way the invention can be used to record and distinguish fluorescent patterns having different fluorescence lifetimes, i.e. exhibiting fluorescence which lasts for different times. With reference to FIG. 3 the shutter opening time 70 would move to the right so that the shutter opens after the light pulse 60 has finished.

By varying the synchronisation, the apparatus and method of the invention can also be used in known modulated detection techniques.

In another embodiment of the invention, the fluorescent pattern can fluoresce at two or more different excitation wavelengths, for example if the fluorescent pattern consists of two or more separate sub-patterns such as security markings, each created with a different dye. The second set of pulsed light sources 20 can be selected to emit light at a second excitation wavelength, different to the first wavelength. For example the first wavelength may be 450 nm and the second wavelength may be 520 nm, although of course any suitable wavelengths may be selected. The optical filter 14 can be selected to block light emitted by both the first and second set of pulsed light sources.

In use, the fluorescent pattern 32 on the object 30 is illuminated alternately by light at the first and second excitation wavelengths from the first and second set of sources 18, 20, which are synchronised by the synchronisation control 22 to emit pulses while the shutter is open for first and second subsequent periods of time. Since the fluorescence is synchronised with the camera shutter, it is detected by the camera 10, thereby allowing the image recording sensor to record the fluorescence excited by the two different wavelengths independently of each other. The optical filter 14 remains in place, and can be a single filter selected to block light emitted by both the first and second pulsed sources, or can comprise two filters which are switched by the apparatus 10 so that the first filter is in place and blocks light emitted by the first pulsed source 18 when the shutter opens to record the first fluorescence, and the second filter is in place and blocks light emitted by the second pulsed source 20 when the shutter opens to record the second fluorescence.

As will be apparent to the skilled person, using the same principle three or more sets of sources can also be used to record the fluorescence excited by the three or more different excitation wavelengths independently of each other.

In the illustrated embodiment the fluorescent pattern is a fingerprint. Although the invention offers significant advantages in the detection and recording of fingerprint images, the invention is applicable to any appropriate form of fluorescent pattern.

The fluorescent pattern may be a security marking which is not readily visible to the naked eye, for example simple spots, fluorescent barcodes or other fluorescent patterns, such as DataMatrix™ patterns. The invention can be used to record a fluorescent image of the security marking as well as a visual image of the object on which the security marking appears. The detection of such markings under ambient illumination offers a significant advantage over prior art detection methods which require a darkened environment. The invention is applicable in anticounterfeiting. The barcodes may be made invisible to users who do not have access to a fluorescence scanner/imager.

The fluorescent pattern may be an anatomical feature subject to fluorescence enhancement, for example a feature which is the subject of medical imaging. For example, fluorescence enhancement has been used in brain and eye surgery, and the invention can be used to record a fluorescent image of the tissue during surgery. The invention can be used in photodynamic diagnosis, a technique used for cancer detection by fluorescence of a drug. The invention can be used with fluorescent dyes to record images obtained during mapping the lymph node system. In all these cases, whether in a laboratory or clinical environment, the capability to operate without the need for dimmed or reduced ambient light offers a significant advantage.

The fluorescent pattern may be a naturally occurring pattern. The invention can be used in biological measurements, since changes of fluorescence are used in many fields of biology.

The fluorescent pattern may be a marker used to record motion or movement. For example the invention could be used to record the motion of a human body to which fluorescent markers are attached as “targets” that are picked up by the camera. The invention could be used in automated manufacturing to assist with identification of parts on a conveyor built or in a manufacturing process.

The present invention provides an apparatus and method which allows the detection and recordal of fluorescent patterns such as fingerprints under ambient light. By imaging the fluorescent pattern with a camera with a shutter that is fast enough to reject ambient light and by synchronising the illumination of the pattern, the system does not require a darkened environment. It can therefore be deployed directly in the field.

The use of two or more different pulsed light sources of different wavelength for different sets of shutter openings, optionally coupled with varied shutter times for different sets of shutter openings, allows the further advantages of quasi-simultaneous imaging at multiple excitation wavelengths, with independent measurement and recordal of the fluorescence response. It also allows independent measurement and recordal of the fluorescent image and of the ambient image, thus creating an effectively simultaneous record of the fluorescent pattern and its location.

The use of a pulse of high intensity light for fluorescence excitation while the shutter is open results in a fluorescence intensity level from the pattern 32 which is much higher than the ambient light when integrated over the shutter opening time. The filter 14 blocks the excitation wavelength and, as the fluorescence intensity is higher than the ambient light, it can be detected by the camera 10.

It should be noted that any suitable form of camera 10 may be used, including digital cameras, both video and still, and ordinary film cameras. In practice it has been found that suitably fast shutter speeds can be obtained by using a digital imager 12, for example CCD camera or CMOS camera. Such cameras also allow video imaging and image acquisition.

The invention offers the advantage over the prior art of being able to work in ambient light, without the need to take the object 30 into a dark room for observation. Moreover, as the light pulses are very short, typically less than 10 μs, the energy delivered by each pulse can be very low. At typical video frame rates of 25 Hz this means that the safety of the system is improved, by reducing the average power to which the operator and bystanders are exposed. Typically when obtaining an image of a fingerprint dyed with Basic Yellow under blue excitation, the average power of the light source is about 10 mW, compared to the conventional light sources which typically have a continuous power consumption of 5 W to 500 W.

Furthermore, because a specific pulse is used on each time frame, it is possible to use different light sources for different image frames, to capture almost simultaneously two different types of image, resulting from different excitation wavelengths, or wavelengths that allow other visualisations apart from fluorescence. A video camera can capture the different types of image on consecutive frames, quasi-simultaneously and independently.

A number of examples of images obtained using the apparatus and method of the invention are now described.

### EXAMPLE 1

### Forensics

FIG. 4 shows a fingerprint image on paper taken by illuminating the fingerprint with 72 LED's emitting at 450 nm, observed using a CCD interline-transfer camera (Unibrain Fire-i 511™) through a barrier filter of Schott™ glass. The shutter time (electronic setting of the integration time of the CCD sensor) is 3 microseconds, synchronous with the LED illumination, which is a pulse of 3 microseconds. The fingerprint is stained with a commercial fluorescent ink. The apparatus of the invention is capable of producing a corresponding image (not shown) of the paper under normal lighting, taken at effectively the same time, which would serve as evidence of the location of the fingerprint.

### EXAMPLE 2

### Medical

FIG. 5 shows an eye pupil image taken by illuminating an eye pupil with 72 LED's emitting at 450 nm, observed using a CCD interline-transfer camera (Unibrain™ Fire-i 511) through a barrier filter of Schott™ glass. The shutter time (electronic setting of the integration time of the CCD sensor) is 3 microseconds, synchronous with the LED illumination, which is a pulse of 3 microseconds. The eye pupil autofluoresces, so requires no staining.

### EXAMPLE 3

### Arts Conservation

FIG. 6 shows an image of a book spine of parchment. The image was taken by illuminating the book with 72 LED's emitting at 450 nm, and by observing using a CCD interline-transfer camera (Unibrain™ Fire-i 511) through a barrier filter of Schott™ glass. The shutter time (electronic setting of the integration time of the CCD sensor) is 3 microseconds, synchronous with the LED illumination, which is also 3 microseconds. Undyed fungal growth can be clearly seen.

### EXAMPLE 4

### Arts Conservation

FIG. 7 shows an image of paint pigment on a book. The image was taken by illuminating the book with 72 LED's emitting at 450 nm, and by observing using a CCD interline-transfer camera (Unibrain™ Fire-i 511) through a barrier filter of Schott™ glass. The shutter time (electronic setting of the integration time of the CCD sensor) is 1 microsecond, synchronous with the LED illumination, which is a pulse of 1 microsecond. One of the pigments, which is dark red under standard illumination, shows bright fluorescence, thus allowing identification.

### EXAMPLE 5

### Security Tagging

FIG. 8 shows a fluorescent ink barcode image on paper. The ink is invisible under normal illumination. The image has been produced by illuminating the book with 72 LED's emitting at 450 nm, and by observing using a CCD interline-transfer camera (Unibrain™ Fire-i 511) through a barrier filter of Schott™ glass. The shutter time (electronic setting of the integration time of the CCD sensor) is 1 microsecond, synchronous with the LED illumination, which is also 1 microsecond. The image shows how the invention can be used to detect under normal light conditions fluorescent ink patterns, such as fluorescent barcodes, which would otherwise be invisible.

1. Imaging apparatus for obtaining an image of a fluorescent pattern under ambient light, comprising:
a synchronous shutter imaging device having an image recording sensor and a shutter,
a first pulsed light source adapted to emit a pulse of light having an excitation wavelength of the fluorescent pattern,
an optical filter adapted to prevent light having the excitation wavelength from reaching the image recording sensor of the synchronous shutter imaging device, and
a synchronisation control adapted to synchronise the shutter of the synchronous shutter imaging device and the pulsed light source.

2. The imaging apparatus of claim 1 wherein the synchronisation control is adapted to synchronise the shutter such that opening of the shutter at least partially overlaps the pulse of light emitted by the first light source.

3. The imaging apparatus of claim 1 or 2, wherein the synchronous shutter imaging device has a shutter speed which is controllable to a first shutter speed which is sufficiently fast to limit ambient light reaching the image recording sensor of the synchronous shutter imaging device to an amount which does not adversely affect the image of the fluorescent pattern.

4. The imaging apparatus of claim 3, wherein the synchronous shutter imaging device has a shutter speed which is controllable to a second shutter speed which allows ambient light to reach the image recording sensor of the synchronous shutter imaging device to produce an image under ambient light.

5. The imaging apparatus of any preceding claim, wherein the imaging apparatus comprises more than one pulsed light source and the synchronisation control is adapted to control the more than one pulsed light source to synchronise the shutter of the synchronous shutter imaging device with each of the more than one pulsed light source.

6. The imaging apparatus of claim 5, wherein each pulsed light source emits light of a different wavelength.

7. The imaging apparatus of any preceding claim, wherein the or each pulsed light source comprises one or more mutually synchronised LEDs or other pulsed lights.

8. The imaging apparatus of claim 6, wherein the pulsed light sources include at least one pulsed light source adapted to emit a pulse of light having an excitation wavelength of the fluorescent pattern and at least one pulsed light source adapted to emit a pulse of light having a different wavelength not blocked by the filter and enabling visualisation of the object.

9. The imaging apparatus of claim 6, wherein the pulsed light sources include at least one pulsed light source adapted to emit a pulse of light having an excitation wavelength of the fluorescent pattern and at least one pulsed light source adapted to emit a pulse of light having a second excitation wavelength of a second fluorescent pattern.

10. The imaging apparatus of any preceding claim, wherein the synchronisation control is adapted to control one or more of the time for which the shutter is open, the duration of the pulse of light, the intensity of the pulse of light, the sensitivity of the synchronous shutter imaging device, and the temporal relationship of the start and finish of the pulse with respect to the opening and closing of the shutter.

11. The imaging apparatus of any preceding claim, wherein the image recording sensor comprises one or more sensing units selected from the group including: CCD units, CMOS units, EMCCD units, MCP intensified units, units containing organic semiconducting materials, photomultipliers, vidicons, photodiodes, photoresistors, microbolometers, and thermal sensors.

12. The imaging apparatus of any preceding claim, wherein the image recording sensor comprises a plurality of sensing units arranged in a matrix.

13. The imaging apparatus of any preceding claim, wherein the imaging device includes a lens or an aperture and the shutter is provided between the image recording sensor and the lens or aperture, or between the fluorescent pattern and the lens or aperture.

14. The imaging apparatus of any preceding claim, wherein the shutter is a gate comprising an electronic gate control of the sensing units of the image recording sensor.

15. The imaging apparatus of any preceding claim, wherein the imaging apparatus comprises a single housing which contains the synchronous shutter imaging device, the one or more pulsed light sources, the optical filter and the synchronisation control.

16. The imaging apparatus of claim 15, wherein the housing includes wired or wireless connection means to allow remote viewing, storage and processing of the image by means of a computer connected to the connection means.

17. A method of obtaining an image of a fluorescent pattern under ambient light using a synchronous shutter imaging device having an image recording sensor and a shutter, the method comprising:
illuminating the fluorescent pattern with a first pulse of light having an excitation wavelength of the fluorescent pattern,
opening the shutter of the synchronous shutter imaging device in synchronisation with the pulse of light for a period of time sufficiently short to limit ambient light reaching the image recording sensor to an amount which does not adversely affect the image of the fluorescent pattern,
collecting emitted fluorescent light from the fluorescent pattern through an optical filter adapted to prevent light having the excitation wavelength from reaching the image recording sensor of the synchronous shutter imaging device, and
recording on the image recording sensor an image generated by the emitted fluorescent light.

18. The method of claim 17 wherein the shutter is opened for a period of time which at least partially overlaps with the time for which the fluorescent pattern is illuminated with the pulse of light.

19. The method of claim 17 or 18, wherein the period of time for which the shutter is opened is 10 μs or less.

20. The method of any of claims 17 to 19, wherein the method comprises the further step of controlling the period of time for which the shutter is open.

21. The method of any of claims 17 to 20, wherein the method comprises the further step of dyeing a pattern with one or more fluorescent dyes to create a fluorescent pattern.

22. The method of any of claims 17 to 21, wherein the fluorescent pattern is autofluorescent.

23. The method of any of claims 17 to 22, wherein the pulsed light source has an excitation wavelength of between 180 nm and 1000 nm.

24. The method of any of claims 17 to 23, wherein the fluorescent pattern is one of the group consisting of a fingerprint, a security marking, a motion detection marker, an identification marker, a fluorescent barcode, and an anatomical feature.

25. The method of any of claims 17 to 24, wherein the method comprises the further step of obtaining a second image of the fluorescent pattern under non-fluorescing conditions by:
illuminating the fluorescent pattern with a second pulse of light having a wavelength other than the excitation wavelength of the fluorescent pattern,
opening the shutter of the synchronous shutter imaging device in synchronisation with the second pulse of light for a second period of time, and
recording on the image recording sensor an image generated by light reflected from the object.

26. The method of claim 25, wherein the first and second pulses of light are generated by first and second pulsed light sources respectively.

27. The method of any of claims 17 to 26, wherein the fluorescent pattern includes two or more sub-patterns having different excitation wavelengths, the method comprising the further step of obtaining a further image of the fluorescent pattern by:
illuminating the fluorescent pattern with a further pulse of light having a wavelength equal to a second excitation wavelength of the fluorescent pattern,
opening the shutter of the synchronous shutter imaging device in synchronisation with the further pulse of light for a further period of time,
collecting emitted fluorescent light from the fluorescent pattern, and
recording on the image recording sensor an image generated by the emitted fluorescent light.

28. The method of claim 27, wherein the further period of time is sufficiently short to limit ambient light reaching the image recording sensor to an amount which does not adversely affect the image of the fluorescent pattern.

29. The method of any of claims 17 to 28, wherein the method comprises the further steps of controlling one or more of the following:
the time for which the shutter is open,
the duration of the pulse or pulses of light,
the intensity of the pulse or pulses of light,
the sensitivity of the synchronous shutter imaging device, and
the temporal relation of the start and finish of the pulse or pulses of light with respect to the opening and closing of the shutter.
